(19) United States
(12) Patent Application Publication
(10) Pub. No.: US 2026/0320887 A1
(43) Pub. Date: Oct. 15, 2026

(54) MOUTH SHAPE DRIVING METHOD AND APPARATUS, AND TRAINING METHOD AND APPARATUS FOR MOUTH SHAPE DRIVING MODEL

(71) Applicant: Beijing Zitiao Network Technology Co., Ltd., Haidian District, Beijing (CN)

(72) Inventors: Jingna SUN, Beijing (CN); Xin DONG, Beijing (CN); Xijin ZHANG, Beijing (CN); Kang DU, Beijing (CN)

(21) Appl. No.: 19/485,573

(22) PCT Filed: May 20, 2024
(86) PCT No.: PCT/CN2024/094189

§ 371 Date: Nov. 18, 2025

(30) Foreign Application Priority Data
May 19, 2023 (CN) 202310572583.4

(51) Int. Cl. G06T 13/20; G10L 15/25; G10L 21/0232

(52) U.S. Cl. CPC G06T 13/205; G10L 15/25; G10L 21/0232

(57) ABSTRACT

A mouth shape driving method comprises: sequentially using, as a target audio feature, each audio feature in an audio feature sequence, and determining, from the audio feature sequence, a target feature sub-sequence corresponding to the target audio feature, wherein the audio feature sequence is obtained by means of performing filtering on audio to be processed; performing first feature extraction on the target feature sub-sequence to obtain an audio intermediate feature; sequentially using, as a target intermediate feature, an audio intermediate feature corresponding to each audio feature, and determining, from audio intermediate features, an intermediate feature sub-sequence corresponding to the target intermediate feature; performing second feature extraction on the basis of the intermediate feature sub-sequence, determining a corresponding audio smoothing feature; and processing an audio smoothing feature corresponding to each audio intermediate feature, and determining a parameter sequence corresponding to the audio feature sequence for generating a mouth shape animation.

### CROSS-REFERENCE TO RELATED APPLICATIONS

The present application is based on and claims the priority to the Chinese application No. 2023105725834 filed on May 19, 2023, the disclosure of which is incorporated herein in its entirety.

### TECHNICAL FIELD

The present disclosure relates to the technical field of mouth shape driving, and in particular to a mouth shape driving method and apparatus, and a training method and apparatus for a mouth shape driving model.

### BACKGROUND

Production of mouth shape animations plays an important role in novel human-machine interactions such as movie, game and virtual reality. When viewing model animations, viewers tend to be sensitive to some subtle changes in model mouth shape actions. Therefore, how to generate realistic and natural mouth shape animations is a first challenging topic in the field of computer graphics today.

### SUMMARY

In one or more embodiments of the present disclosure, there are provided a mouth shape driving method and apparatus, and a training method and apparatus for a mouth shape driving model, to extract a mouth shape driving parameter that helps to smooth a mouth shape, to reduce mouth shape jitters.

According to a first aspect, there is provided a mouth shape driving method, including: determining, by sequentially using each audio feature in an audio feature sequence as a target audio feature, a target feature sub-sequence corresponding to the target audio feature from the audio feature sequence, where the audio feature sequence is a feature sequence obtained by filtering an audio to be processed;
performing first feature extraction on the target feature sub-sequence to obtain an audio intermediate feature;
determining, by sequentially using the audio intermediate feature corresponding to each audio feature as a target intermediate feature, an intermediate feature sub-sequence corresponding to the target intermediate feature from each audio intermediate feature;
performing second feature extraction on the basis of the intermediate feature sub-sequence to determine a corresponding audio smoothing feature; and
processing the audio smoothing feature corresponding to each audio intermediate feature, to determine a target mouth shape driving parameter sequence corresponding to the audio feature sequence that is used for generating a mouth shape animation.

According to a second aspect, there is provided a training method for a mouth shape driving model, where the mouth shape driving model includes a first extraction layer, a second extraction layer and a first output layer; the method including:
determining a current parameter of the first extraction layer;
determining, by sequentially using each sample audio feature in a sample audio feature sequence as a first feature, a first feature sub-sequence corresponding to the first feature from the sample audio feature sequence, where the sample audio feature sequence is a feature sequence obtained by filtering a sample audio;
performing first feature extraction on the first feature sub-sequence by using the current parameter of the first extraction layer to obtain a sample intermediate feature;
determining, by sequentially using the sample intermediate feature corresponding to each sample audio feature as a second feature, a second feature sub-sequence corresponding to the second feature from the sample intermediate features;
performing second feature extraction on the basis of the second feature sub-sequence by using the second extraction layer to determine a corresponding sample smoothing feature;
processing a sample smoothing feature corresponding to each sample intermediate feature by using the first output layer, to determine a mouth shape driving prediction parameter sequence corresponding to the sample audio feature sequence; and
adjusting parameters of the second extraction layer and first output layer on the basis of the mouth shape driving prediction parameter sequence and a mouth shape driving label parameter sequence corresponding to the sample audio feature sequence.

According to a third aspect, there is provided a mouth shape driving apparatus, including:
a first determination module configured to determine, by sequentially using each audio feature in an audio feature sequence as a target audio feature, a target feature sub-sequence corresponding to the target audio feature from the audio feature sequence, where the audio feature sequence is a feature sequence obtained by filtering an audio to be processed;
a first feature extraction module configured to perform first feature extraction on the target feature sub-sequence to obtain an audio intermediate feature;
a second determination module configured to determine, by sequentially using the audio intermediate feature corresponding to each audio feature as a target intermediate feature, an intermediate feature sub-sequence corresponding to the target intermediate feature from each audio intermediate feature;
a second feature extraction module configured to perform second feature extraction on the basis of the intermediate feature sub-sequence to determine a corresponding audio smoothing feature; and
a first processing module configured to process the audio smoothing feature corresponding to each audio intermediate feature, to determine a mouth shape driving parameter sequence corresponding to the audio feature sequence that is used for generating a mouth shape animation.

According to a fourth aspect, there is provided a training apparatus for a mouth shape driving model, where the mouth shape driving model includes a first extraction layer, a second extraction layer and a first output layer; the apparatus including:
a third determination module configured to determine a current parameter of the first extraction layer;
a fourth determination module configured to determine, by sequentially using each sample audio feature in a sample audio feature sequence as a first feature, a first feature sub-sequence corresponding to the first feature from the sample audio feature sequence, where the sample audio feature sequence is a feature sequence obtained by filtering a sample audio;
a third feature extraction module configured to perform first feature extraction on the first feature sub-sequence by using the current parameter of the first extraction layer to obtain a sample intermediate feature;
a fifth determination module configured to determine, by sequentially using the sample intermediate feature corresponding to each sample audio feature as a second feature, a second feature sub-sequence corresponding to the second feature from the sample intermediate features;
a fourth feature extraction module configured to perform second feature extraction on the basis of the second feature sub-sequence by using the second extraction layer to determine a corresponding sample smoothing feature;
a second processing module configured to process the sample smoothing feature corresponding to each sample intermediate feature by using the first output layer, to determine a mouth shape driving prediction parameter sequence corresponding to the sample audio feature sequence; and
a first adjustment module configured to adjust parameters of the second extraction layer and first output layer on the basis of the mouth shape driving prediction parameter sequence and a mouth shape driving label parameter sequence corresponding to the sample audio feature sequence.

According to a fifth aspect, there is provided a computer-readable storage medium having thereon stored a computer program which, when executed in a computer, causes the computer to perform the method according to the first or second aspect.

According to a sixth aspect, there is provided an electronic device, including a memory and a processor, where the memory has therein stored executable code which, when executed by the processor, implements the method according to the first or second aspect.

According to the mouth shape driving method and apparatus, and the training method and apparatus for the mouth shape driving model provided in the embodiments of the present disclosure, the mouth shape driving method includes: determining, by sequentially using each audio feature in an audio feature sequence as a target audio feature, a target feature sub-sequence corresponding to the target audio feature from the audio feature sequence, where the audio feature sequence is a feature sequence obtained by filtering an audio to be processed; performing first feature extraction on the target feature sub-sequence to obtain an audio intermediate feature; determining, by sequentially using the audio intermediate feature corresponding to each audio feature as a target intermediate feature, an intermediate feature sub-sequence corresponding to the target intermediate feature from each audio intermediate feature; performing second feature extraction on the basis of the intermediate feature sub-sequence to determine a corresponding audio smoothing feature; and processing the audio smoothing feature corresponding to each audio intermediate feature, to determine a mouth shape driving parameter sequence corresponding to the audio feature sequence that is used for generating a mouth shape animation. In the above process, after the first feature extraction is performed, sliding window is performed for the obtained audio intermediate feature corresponding to each audio feature to obtain the corresponding intermediate feature sub-sequence, and then the second feature extraction is performed on the intermediate feature sub-sequence, achieving the effect of performing secondary feature extraction on the features obtained after the feature extraction, so that the audio smoothing feature containing information of more adjacent audio features can also be obtained without increasing the sliding window, and generation of mouth shape driving parameters by using such features can make the mouth shape animation corresponding to the mouth shape driving parameters smoother, reducing mouth shape jitters in the mouth shape animation.

### BRIEF DESCRIPTION OF THE DRAWINGS

In order to more clearly illustrate the technical solutions of the embodiments of the present disclosure, the drawings to be used in the description of the embodiments will be briefly introduced below. It is apparent that the drawings in the following description are merely some embodiments of the present disclosure and for one of ordinary skill in the art, other drawings may be obtained according to these drawings without paying creative labor.

FIG. 1A is a schematic flow diagram of a training method for a mouth shape driving model according to an embodiment;

FIG. 1B is a schematic diagram of a data processing process of a mouth shape driving model according to an embodiment;

FIG. 2A is a schematic representation diagram of a sample intermediate feature;

FIG. 2B is a schematic representation diagram of a second feature sub-sequence;

FIG. 2C is a schematic diagram of a feature sub-sequence obtained to be processed after dimension adjustment operation is performed on each sample intermediate feature in the second feature sub-sequence shown in FIG. 2B;

FIG. 3 is a schematic flow diagram of a mouth shape driving method according to an embodiment;

FIG. 4 is a schematic block diagram of a mouth shape driving apparatus according to an embodiment;

FIG. 5 is a schematic block diagram of a training apparatus for a mouth shape driving model according to an embodiment;

FIG. 6 is a schematic block diagram of an electronic device according to an embodiment.

### DETAILED DESCRIPTION

Technical solutions of the embodiments of the present disclosure will be described in detail below with reference to the accompanying drawings.

It can be understood that, before the technical solutions disclosed in the embodiments of the present disclosure are used, a type, use range, use scenario, etc. of personal information involved in the present disclosure should be informed to a user in an appropriate manner according to the related laws and regulations and authorized from the user.

For example, in response to receiving an active request of a user, a prompt is sent to the user to explicitly prompt the user that an operation he requests to be performed would require acquisition and use of personal information to the user. Thus, the user can, according to the prompt, autonomously select whether to provide the personal information to software or hardware such as an electronic device, application, server, or storage medium that performs operations of the technical solutions of the present disclosure.

As an optional but non-limiting implementation, in response to receiving an active request of a user, a prompt may be sent to the user, for example, in a manner of a pop-up window, where the prompt may be presented in a manner of text. In addition, in the pop-up window, a selection control provided for the user to select “Agree” or “Disagree” on providing the personal information to an electronic device may be carried.

It can be understood that the above processes of notification and authorization from the user are only illustrative and not intended to limit the implementation of the present disclosure, and other manners in which the related laws and regulations are satisfied may also be applied in the implementation of the present disclosure.

In methods of generating mouth shape animations, there are a series of methods of using audio driving, in which, by generally using an audio as an input, a piece of mouth shape animation synchronized with the audio is generated. In the process of generating the mouth shape animation by using audio driving, mouth shape jitters between frames often occur.

Then, there is a need to provide an improved solution to alleviate mouth shape jitters between frames in the process of generating the mouth shape animation by the audio driving.

In one or more embodiments of the present disclosure, there are provided a mouth shape driving method and apparatus, and a training method and apparatus for a mouth shape driving model, to extract a mouth shape driving parameter that helps to smooth a mouth shape to reduce mouth shape jitters.

As described above, in the process of generating the mouth shape animation by using the audio driving, mouth shape jitters between image frames (which may also be referred to as animation frames) often occur. At present, the process of generating the mouth shape animation by using the audio driving generally is: acquiring an audio to be processed, and filtering the audio to be processed to obtain its corresponding audio to be processed feature sequence; determining, for each audio to be processed feature in the audio to be processed feature sequence, its corresponding feature sub-sequence by means of a sliding window; and then, determining, by using the feature sub-sequence corresponding to each audio to be processed feature, a mouth shape driving parameter sequence corresponding to the audio to be processed feature sequence that is used for generating the mouth shape animation, and then determining a corresponding mouth shape image frame sequence (i.e., the mouth shape animation, which may correspondingly be referred to as a mouth shape animation frame sequence) on the basis of the mouth shape driving parameter sequence.

In the above process, in order to reduce the mouth shape jitters between image frames, the sliding window is generally increased (i.e. a window length of the sliding window is increased), where increasing the sliding window can, theoretically, alleviate the mouth shape jitters between image frames. However, when the sliding window is increased to a certain extent, the effect of alleviating the mouth shape jitters between image frames is insignificant, and a significant mouth shape delay will be brought about.

In order to better reduce the mouth shape jitters on the premise of ensuring real-time driving of the mouth shape, the embodiments of the present disclosure disclose a mouth shape driving method and apparatus and a training method and apparatus for a mouth shape driving model, and the mouth shape driving method and apparatus and the training method and apparatus for the mouth shape driving model provided by the disclosure are elaborated below in conjunction with specific embodiments.

It can be understood that a mouth shape driving process provided in the embodiments of the present disclosure may be implemented on the basis of a pre-trained mouth shape driving model. For clarity of layout, a training process of the mouth shape driving model is first described below.

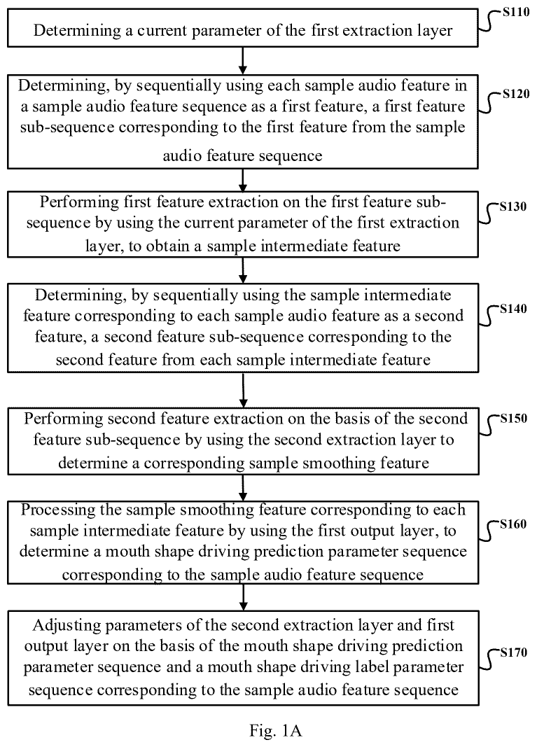

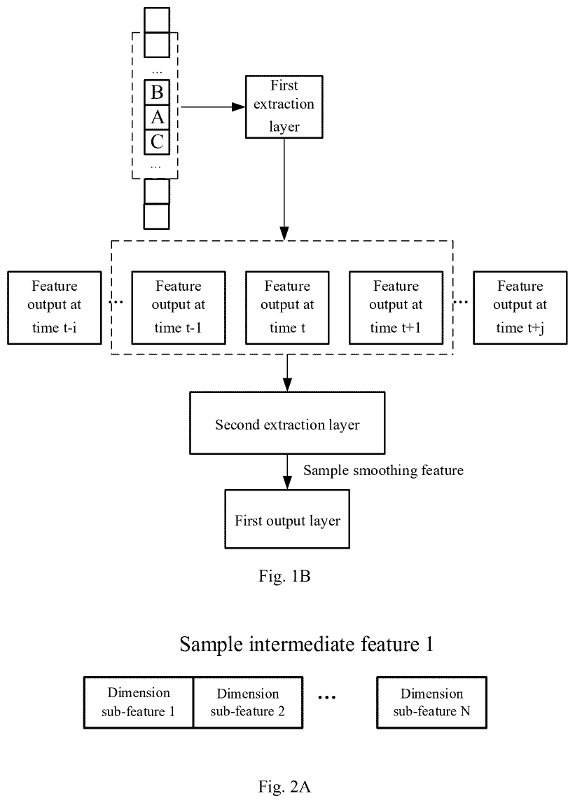

In the training process of the mouth shape driving model, as shown in FIG. 1A, a schematic flow diagram of a training method for a mouth shape driving model in some embodiments of the present disclosure is shown, and as shown in FIG. 1B, the mouth shape driving model may include a first extraction layer, a second extraction layer and a first output layer. The method may be implemented by a target program. The target program may be installed in an electronic device, which may be implemented by any apparatus, device, platform, device cluster, etc. having computing and processing capabilities.

It should be noted that, in a process of an audio driving a mouth shape, for a mouth shape driving parameter for generating a mouth shape driving animation that is determined on the basis of the audio, i.e., an output of the mouth shape driving model, it may be in a mesh form, or a blendshape weight set form, or a viseme form. In the embodiment of the present disclosure, corresponding to different forms of the mouth shape driving parameter, the first output layer of the mouth shape driving model may be a classification layer or a regression layer. When the first output layer is the classification layer (referred to as a first classification layer), the mouth shape driving parameter output by the first output layer may be in the viseme form; and when the first output layer is a first regression layer, the mouth shape driving parameter output by the first output layer may be in the mesh form or the blendshape weight set form.

When the first output layer of the mouth shape driving model is the first classification layer or the first regression layer, their training processes (and processes of determining the mouth shape driving parameter) are similar, while label data required for the training are different, where when the first output layer of the mouth shape driving model is the first classification layer, the label data thereof includes a mouth shape driving parameter label in the viseme form; and when the first output layer of the mouth shape driving model is the first regression layer, the label data thereof includes a mouth shape driving parameter label in the mesh form, or the label data thereof includes a mouth shape driving parameter label in the blendshape weight set form.

The training process of the mouth shape driving model is described below, and as shown in FIG. 1A, the training method for the mouth shape driving model may include the following steps S110-S170:
Step S110, determining a current parameter of the first extraction layer.

In one implementation, the target program may, from a preset storage space of the electronic device where the target program is located, read a current parameter of the first extraction layer, that is, read a value of the current parameter of the first extraction layer, and then execute a subsequent training process of the mouth shape driving model on the basis of the current parameter of the first extraction layer. The first extraction layer may be a pre-trained extraction layer.

In another implementation, the target program may determine a current parameter of the first extraction layer by training. Correspondingly, the training process of the mouth shape driving model provided in the embodiment of the present disclosure may be divided into two stages, namely, a first stage which is a training stage for the first extraction layer, and a second stage which is, on the basis of the trained first extraction layer, a training stage for the second extraction layer and the first output layer, where in the training process of the second extraction layer and the first output layer, the current parameter (namely, the value of the current parameter) of the first extraction layer may be fixed. It can be appreciated that, this first extraction layer may be implemented on the basis of any neural network layer in the related art that can extract an audio feature.

The training stage (i.e., the first stage) for the first extraction layer is described below. Specifically, the target program may first acquire a first extraction layer to be trained and an output layer (which may be a classification layer or regression layer) corresponding to the first extraction layer, and for clarity of description, the output layer corresponding to the first extraction layer is referred to as a second output layer. When the first output layer of the mouth shape driving model is the classification layer (referred to as a first classification layer), in training the first extraction layer, a second output layer corresponding to the first extraction layer is a classification layer, referred to as a second classification layer. When the first output layer of the mouth shape driving model is the regression layer (referred to as a first regression layer), in training the first extraction layer, a second output layer corresponding to the first extraction layer is a regression layer, referred to as a second regression layer.

Then, the target program acquires training data required for training the first extraction layer and the second output layer, where the training data includes a training audio feature sequence corresponding to audio data (referred to as training audio) and its corresponding label data, where the label data includes a mouth shape driving parameter sequence corresponding to the training audio feature sequence, and the mouth shape driving parameter sequence corresponding to the training audio feature sequence is referred to as a first mouth shape driving parameter sequence for clarity of description.

When the first extraction layer corresponds to the second classification layer, that is, the second output layer is the second classification layer, the first mouth shape driving parameter sequence exists in a viseme form and includes a phoneme sequence. It can be appreciated that, first mouth shape driving parameters in the first mouth shape driving parameter sequence are in a one-to-one correspondence with training audio features in the training audio feature sequence.

Correspondingly, the phonemes in the phoneme sequence are in a one-to-one correspondence with the training audio features, and on the basis of the phonemes in the phoneme sequence, it is possible to determine corresponding mouth shape animation frames (i.e., determine mouth shape animation frames corresponding to the training audio features), and then generate a corresponding mouth shape animation. Or on the basis of the phoneme sequence, it is possible to determine a blendshape weight set corresponding to the phonemes therein, and then on the basis of the blendshape weight set corresponding to the phonemes, it is possible to obtain mouth actions, i.e. mouth shapes, corresponding to the phonemes, and then generate a corresponding mouth shape animation.

When the first extraction layer corresponds to the second regression layer, that is, the second output layer is the second regression layer, in one case, the first mouth shape driving parameter sequence may exist in a mesh form, first mouth shape driving parameters in the first mouth shape driving parameter sequence are a position information set corresponding to a set of a group of preset mouth shape key points (or a group of preset face key points including the preset mouth shape key points), and on the basis of the position information set, corresponding mouth actions, i.e., mouth shapes (or face expression actions including the mouth shapes) may be obtained, and correspondingly, on the basis of the first mouth shape driving parameter sequence, a corresponding mouth shape animation may be obtained.

When the first abstraction layer corresponds to the second regression layer, in another case, the first mouth shape driving parameter sequence may exist in a form of blendshape weight set, that is, the first mouth shape driving parameter sequence is a weight set sequence. The training audio feature sequence includes several training audio features, where each training audio feature can separately correspond to a set of a group of weights, which is a blendshape weight set, and for each training audio feature, by combining the blendshape weight set corresponding to the training audio feature, it is possible to obtain at least mouth actions, i.e. mouth shapes, and then generate corresponding mouth shape animation frames, and correspondingly, by combining the blendshape weight set corresponding to each training audio feature in the training audio feature sequence, it is possible to obtain mouth motions, i.e. mouth shapes, corresponding to the training audio features, and then generate a corresponding mouth shape animation.

In some embodiments, the training audio feature sequence corresponding to the training audio may be a feature sequence obtained by filtering the training audio, specifically, an Mel frequency cepstrum coefficient (MFCC) feature sequence corresponding to the training audio that is obtained after the training audio is filtered by using a preset MFCC filtering algorithm.

After obtaining the training audio feature sequence corresponding to the training audio, the target program sequentially uses each training audio feature in the training audio feature sequence as a feature to be processed (referred to as a third feature), and determines a third feature sub-sequence corresponding to the third feature from the training audio feature sequence. In one implementation, the target program may determine a third feature sub-sequence corresponding to the third feature from the training audio feature sequence by means of a sliding window, where the third feature sub-sequence may include the third feature, a third number m of training audio features before the third feature and a fourth number n of training audio features after the third feature in the training audio feature sequence. The third number m and the fourth number n are values preset according to actual needs.

In one implementation, when the number of training audio features before the third feature in the training audio feature sequence is less than the third number m, it may be complemented to m by using a preset filling rule. Specifically, filling may be performed by using a first training audio feature in the training audio feature sequence. Similarly, when the number of training audio features after the third feature in the training audio feature sequence is less than the fourth number n, it may be complemented to n by using the preset filling rule. Specifically, filling may be performed by using a last training audio feature in the training audio feature sequence.

After obtaining the third feature sub-sequence corresponding to the third feature, the target program inputs the third feature sub-sequence into the first extraction layer, and performs first feature extraction on the third feature sub-sequence by using the first extraction layer, to obtain a training intermediate feature corresponding to the third feature (i.e., the third feature sub-sequence). Then, the training intermediate feature is input into the second output layer and processed by using the second output layer, to obtain a current mouth shape driving parameter corresponding to the third feature (i.e., the third feature sub-sequence). Correspondingly, it is possible to obtain, by using the second output layer, a current mouth shape driving parameter sequence corresponding to the training audio feature sequence on the basis of the training intermediate feature corresponding to each training audio feature in the training audio feature sequence.

Then, the target program may adjust parameters of the first extraction layer and second output layer on the basis of the current mouth shape driving parameter sequence and the first mouth shape driving parameter sequence corresponding to the training audio feature sequence. Specifically, the target program may determine a corresponding prediction loss (referred to as a first prediction loss) on the basis of the current mouth shape driving parameter sequence and the first mouth shape driving parameter sequence corresponding to the training audio feature sequence by using a preset loss function, and then adjust parameters of the first extraction layer and second output layer with a goal of minimizing the first prediction loss, until the first extraction layer and the second output layer reach a first convergence condition, to obtain the current parameter of the first extraction layer. The first convergence condition may include, but is not limited to: the number of parameter adjustments being not less than a first adjustment threshold, or the calculated first prediction loss being less than the first loss threshold.

In one case, when the first extraction layer corresponds to the second classification layer (i.e., the second output layer is the second classification layer), the preset loss function may be a cross-entropy loss function. In another case, when the first extraction layer corresponds to the second regression layer (i.e. the second output layer is the second regression layer), the preset loss function may be an MSE (mean-square error) loss function.

Looking back at the foregoing training processes of the first extraction layer and the second output layer, the above embodiment is described by taking an example that a training audio feature sequence corresponding to one training audio is one sample. In another embodiment, it is possible to perform the above training process for a batch of samples, i.e., a training audio feature sequence corresponding to a plurality of training audios, to separately obtain a current mouth shape driving parameter sequence corresponding to the training audio feature sequence corresponding to each training audio, and then jointly determine a first prediction loss on the basis of the current mouth shape driving parameter sequence corresponding to the training audio feature sequence corresponding to each training audio and a first mouth shape driving parameter sequence corresponding to each training audio feature sequence, and then train the first extraction layer and the second output layer with a goal of minimizing the first prediction loss. In this embodiment, the first prediction loss is determined for the batch of samples, and then parameters of the first extraction layer and second output layer are adjusted, so that the number of the adjustments of the parameters of the first extraction layer and second output layer can be reduced, making it easier to implement the training process.

After determining the current parameter of the first extraction layer, in step S120, by sequentially using each sample audio feature in a sample audio feature sequence as a first feature, a first feature sub-sequence corresponding to the first feature is determined from the sample audio feature sequence, where the sample audio feature sequence is a feature sequence obtained by filtering a sample audio.

The target program may first acquire data for training the second extraction layer and first output layer of the mouth shape driving model, which is referred to as sample data, where the sample data includes the sample audio feature sequence obtained by filtering the sample audio and a mouth shape driving label parameter sequence corresponding to the sample audio feature sequence.

In one implementation, the sample audio feature sequence may be an audio feature sequence obtained by filtering the sample audio by using a preset Mel frequency cepstrum coefficient (MFCC) filtering algorithm. The sample audio feature sequence includes several sample audio features in a sequential order, and the mouth shape driving label parameter sequence includes several mouth shape driving label parameters corresponding to the several sample audio features.

In one implementation, between the sample data for training the second abstraction layer and the first output layer and the training data for training the first abstraction layer and the second output layer, there may be the same data or different data.

In one case, when the first output layer of the mouth shape driving model is the first classification layer, the mouth shape driving label parameter sequence exists in the viseme form, and includes a phonemes sequence.

In another case, when the first output layer of the mouth shape driving model is the first regression layer, the mouth shape driving label parameter sequence may exist in the mesh form (for example, it is a mouth shape key point position sets sequence), where each sample audio feature included in the sample audio feature sequence may separately correspond to a set of a group of mouth shape key point positions; or the mouth shape driving label parameter sequence exists in the blendshape weight set form (for example, it is a weight set sequence), where each sample audio feature included in the sample audio feature sequence separately corresponds to a set of a group of blendshape weights.

In one implementation, in the step S120, it is possible to, by means of a sliding window, by sequentially using each sample audio feature in the sample audio feature sequence as the first feature, determine the first feature sub-sequence corresponding to the first feature from the sample audio feature sequence. Specifically, it is possible to, by presetting a sliding window (referred to as a first sliding window), slide the first sliding window on the sample audio feature sequence to determine, for each sample audio feature in the sample audio feature sequence, the corresponding feature sub-sequence from the sample audio feature sequence.

A length of this first sliding window may be set according to actual needs. As shown in FIG. 1B, for a first feature A (e.g., a sample audio feature A), a first feature sub-sequence corresponding to the first feature A is determined from the sample audio feature sequence, where the first feature sub-sequence corresponding to the first feature A may include the first feature A, a third number m of sample audio features before the first feature A and a fourth number n of sample audio features after the first feature A in the sample audio feature sequence. In one case, the length of the first sliding window may be set to 23, and accordingly, the third number m may be set to 15, and the fourth number n may be set to 7.

In one implementation, when the number of sample audio features before the first feature in the sample audio feature sequence is less than the third number m, it may be complemented to m by using a preset filling rule. Filling may be performed by using a first sample audio feature in the sample audio feature sequence. Similarly, when the number of sample audio features after the first feature in the sample audio feature sequence is less than the fourth number n, it may be complemented to n by using the preset filling rule. Filling may be performed by using a last sample audio feature in the sample audio feature sequence.

After the first feature sub-sequence corresponding to the first feature (i.e. a certain sample audio feature) is obtained, in step S130, first feature extraction is performed on the first feature sub-sequence by using the current parameter of the first extraction layer, to obtain a sample intermediate feature. In this step, the target program inputs the first feature sub-sequence into the foregoing first extraction layer trained, and performs first feature extraction on the first feature sub-sequence by using the current parameter of the first extraction layer, to obtain the sample intermediate feature corresponding to the first feature sub-sequence (i.e., the first feature).

The target program may obtain, for each sample audio feature, its corresponding sample intermediate feature by using the current parameter of the first extraction layer, where each sample intermediate feature may be ordered in an order of its corresponding sample audio feature, and it may also be considered that each sample intermediate feature is ordered in an output time sequence of its corresponding first extraction layer. As shown in FIG. 1B, the sample intermediate feature corresponding to the first feature A (i.e., the sample audio feature A) may be represented as a feature output by the first extraction layer at a time t. Correspondingly, a sample intermediate feature corresponding to a sample audio feature B before the first feature A in the sample audio feature sequence may be represented as a feature output by the first extraction layer at a time t−1; and a sample intermediate feature corresponding to a sample audio feature C after the first feature A in the sample audio feature sequence may be represented as a feature output by the first extraction layer at a time t+1, and so on.

After the target program obtains the sample intermediate features corresponding to the sample audio features (or obtains sample intermediate features corresponding to at least n sample audio features after the sample audio feature currently used as the first feature), in step S140, by sequentially using the sample intermediate feature corresponding to each sample audio feature as a second feature, a second feature sub-sequence corresponding to the second feature is determined from the sample intermediate features.

In some embodiments, the target program may, by sequentially using the sample intermediate feature corresponding to each sample audio feature as a second feature, determine, from the sample intermediate features, a second feature sub-sequence corresponding to the second feature by means of a sliding window (for example, a second sliding window), where the second feature sub-sequence may include the second feature, a first number of sample intermediate features before the second feature and a second number of sample intermediate features after the second feature, that is, a length (i.e., a window number) of the second sliding window is equal to a sum of the first number, the second number, and 1. Specifically, for the process of determining the second feature sub-sequence corresponding to the second feature, reference may be made to the foregoing process of determining the first feature sub-sequence corresponding to the first feature, which is not repeated here.

In one case, in order to ensure real time of the mouth shape driving, a value of the second number won't be too large, for example, not beyond a preset value, for example, 1 or 2 may be taken for the second number. In one implementation, the first number may be less than the above third number m, and the second number may be less than the above fourth number n, to better ensure real time of the driving while jitters between frames can be improved.

Then, in step S150, second feature extraction is performed on the basis of the second feature sub-sequence by using the second extraction layer to determine a corresponding sample smoothing feature. In this step, the second feature sub-sequence is input into the second extraction layer, and second feature extraction is performed on the basis of the second feature sub-sequence by using the parameter of the second extraction layer, to determine the corresponding sample smoothing feature.

In some embodiments, the second extraction layer may be a fully convolutional network, to perform second feature extraction on the second feature sub-sequence, so as to perform feature extraction again on the basis of the sample intermediate feature (fused with the information of the sample audio features in the first feature sub-sequence corresponding to the sample intermediate feature) extracted in the first extraction layer, so that the obtained sample smoothing feature is therein fused with information of the sample intermediate features in the second feature sub-sequence (i.e., the sample audio features in the first feature sub-sequence that respectively corresponds to the sample feature intermediates in the second feature sub-sequence). Compared with the sample intermediate feature corresponding to each sample smoothing feature, each sample smoothing feature is fused with information of more sample audio features, and the mouth shape driving parameter is generated by using such features, to make the mouth shape animation corresponding to the mouth shape driving parameter smoother, so as to reduce mouth shape jitters in the mouth shape animation. Accordingly, in one case, the second extraction layer may also be referred to as a smoother, capable of alleviating the mouth shape jitters in the mouth shape driving.

In some embodiments, it is possible to directly input the second feature sub-sequence into the second extraction layer, and perform second feature extraction on the second feature sub-sequence by using the parameter of the second extraction layer, to determine the sample smoothing feature corresponding to the second feature sub-sequence (i.e., the second feature).

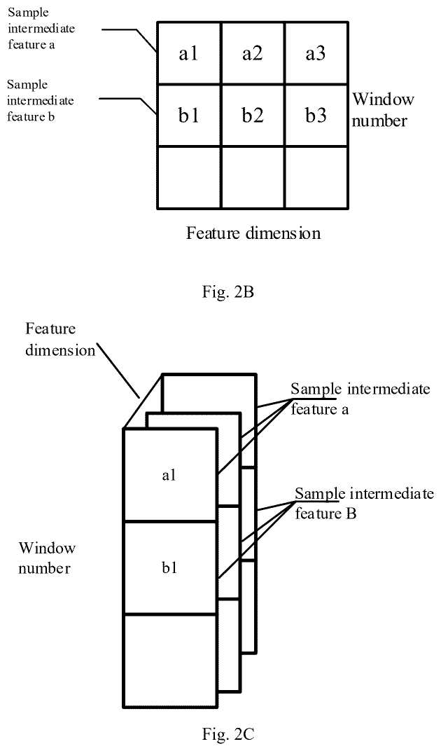

In other embodiments, each sample intermediate feature output by the first extraction layer may include a plurality of dimension sub-features (as shown in FIG. 2A, a sample intermediate feature 1 may include a dimension sub-feature 1 corresponding to a feature dimension 1, a dimension sub-feature 2 corresponding to a feature dimension 2, and a dimension sub-feature N corresponding to a feature dimension N).

The target program obtains, by means of the sliding window, the second feature sub-sequence corresponding to the sample intermediate feature as the second feature, the second feature sub-sequence including sample intermediate features in the window number of the used sliding window (i.e., the foregoing second sliding window), where one sample intermediate feature may be referred to as one window feature, and one sample intermediate feature includes a plurality of dimension sub-features, that is, one window feature includes the plurality of dimension sub-features. Accordingly, dimension representation of the second feature sub-sequence may be (batchsize, window number, feature dimension), where the batchsize represents a batch size of the training data of the mouth shape driving model, the window number represents a height of the second feature sub-sequence, and the number of the feature dimension represents a width of the second feature sub-sequence.

As shown in FIG. 2B, it is a schematic representation diagram of a second feature sub-sequence, as shown in FIG. 2B, the window number, i.e., the height of the second feature sub-sequence, is 3, and the number of the feature dimension, i.e., the width of the second feature sub-sequence, is 3, where one square represents one dimension sub-feature, and one row of dimension sub-features represents one sample intermediate feature, i.e., one window feature.

Considering that for the second extraction layer, it may be a fully convolutional network, with dimension representation of input data therefor of (batchsize, channel, height, width), and considering that the number of feature dimension is represented as the width of the second feature sub-sequence, when feature fusion extraction (convolution processing) is directly performed on the second feature sub-sequence by using the second extraction layer, there may be a situation where each dimension sub-feature of the sample intermediate feature is split for fusion, resulting in incomplete fusion of each dimension sub-feature of the sample intermediate feature (window feature).

Specifically, on the basis of the second feature sub-sequence shown in FIG. 2B, if a convolutional kernel included in the second extraction layer has a size of 2*2, accordingly, when convolution (feature fusion extraction) on the second feature sub-sequence is performed by using the convolutional kernel of 2*2, for a sample intermediate feature a shown in a first row, by using the convolutional kernel of 2*2, convolution can be performed only on two dimension sub-features a1 and a2 (and two dimension sub-features b1 and b2 of a sample intermediate feature b) of the sample intermediate feature a at the same time, while another dimension sub-feature a3 (and b3 of the sample intermediate feature b) is split, and complete fusion cannot be performed.

In order to better and more completely fuse the plurality of dimension sub-features included in the each sample intermediate feature, that is, to better and more completely fuse each window feature, in the step S150, the target program may perform a dimension adjustment operation (for example, reshape operation) on each sample intermediate feature in the second feature sub-sequence, to obtain a feature sub-sequence including each sample intermediate feature after dimension adjustment, which may be referred to as a feature sub-sequence to be processed. By the dimension adjustment operation, the dimension sub-features included in each sample intermediate feature (window feature) may be set as inputs to different channels of the second extraction layer. Dimension representation of each sample intermediate feature after dimension adjustment may be (batchsize, feature dimension, window number, 1). As shown in FIG. 2C, it is a schematic diagram of a feature sub-sequence to be processed obtained after a dimension adjustment operation is performed on each sample intermediate feature in the second feature sub-sequence shown in FIG. 2B.

After the dimension adjustment operation is performed on each sample intermediate feature in the second feature sub-sequence, all the dimension sub-features corresponding to each sample intermediate feature (i.e., each window feature) are taken as the inputs to the different channels of the second extraction layer. In one implementation, the second extraction layer may include several convolutional layers, and all the dimensional sub-features corresponding to each sample intermediate feature (i.e., each window feature) mentioned here, as the inputs to the different channels of the second extraction layer, may refer to inputs to different channels of a first convolutional layer of the second extraction layer.

Next, in the step S150, the target program may perform second feature extraction on the feature sub-sequence to be processed by using the second extraction layer to obtain the sample smoothing feature corresponding to the second feature. For example, when convolution is performed on any sample intermediate feature (e.g., the sample intermediate feature a shown in FIG. 2C) in the feature sub-sequence to be processed by using a convolutional kernel (e.g., a convolutional kernel with a size of 2*1) in the first convolutional layer of the second extraction layer, first, convolution is performed, on each channel, on the sample intermediate feature a by using a 2*1 convolutional kernel corresponding to each channel, to obtain a convolution result of each channel, and then weighted summation is performed on the convolution result of each channel to obtain a final convolution result corresponding to the sample intermediate feature a. The obtained final convolution result includes all the dimension sub-features included in the sample intermediate feature a, and includes all the dimension sub-features included in its adjacent sample intermediate feature b, so as to implement complete convolution on different sample intermediate features, to obtain the final convolution result including more comprehensive information. Correspondingly, the obtained sample smoothing feature corresponding to the second feature sub-sequence (i.e., the second feature) includes more comprehensive sample audio feature information, and the mouth shape driving parameter is generated by using such features, so as to make the mouth shape animation corresponding to the mouth shape driving parameter smoother, better reducing mouth shape jitters in the mouth shape animation.

Then, in step S160, the sample smoothing feature corresponding to each sample intermediate feature is processed by using the first output layer, to determine a mouth shape driving prediction parameter sequence corresponding to the sample audio feature sequence.

In this step, the sample smoothing feature corresponding to each sample intermediate feature is input into the first output layer, and the sample smoothing feature corresponding to each sample intermediate feature is processed by using the parameter of the first output layer, to determine the mouth shape driving prediction parameter sequence corresponding to the sample audio feature sequence. In one case, the first output layer may be implemented by a fully connected layer.

The first output layer may be a classification layer or regression layer. Specifically, When the first output layer is the first classification layer, the mouth shape driving prediction parameter sequence may exist in the viseme form, and is a phoneme sequence. When the first output layer is the first regression layer, the mouth shape driving prediction parameter sequence may exist in the mesh form (for example, a mouth shape key point position set sequence), where each sample audio feature included in the sample audio feature sequence separately corresponds to a set of a group of mouth shape key point positions; or the mouth shape driving prediction parameter sequence may exist in the blendshape weight set form (it is a weight set sequence), where each sample audio feature corresponds to a set of a group of weights, including several blendshape weights.

After the mouth shape driving prediction parameter sequence corresponding to the sample audio feature sequence is determined, in step S170, parameters of the second extraction layer and first output layer are adjusted on the basis of the mouth shape driving prediction parameter sequence and a mouth shape driving label parameter sequence corresponding to the sample audio feature sequence.

Specifically, a corresponding prediction loss (referred to as a current prediction loss) is determined on the basis of the mouth shape driving prediction parameter sequence and the mouth shape driving label parameter sequence corresponding to the sample audio feature sequence by using a preset loss function, and then the parameters of the second extraction layer and first output layer are adjusted with a goal of minimizing the current prediction loss, until the second extraction layer and the first output layer reach a second convergence condition, to obtain a trained second extraction layer and first output layer.

The second convergence condition may include, but is not limited to, the number of parameter adjustments not being less than a second adjustment threshold, or the calculated current prediction loss being less than the second loss threshold. The second adjustment threshold may be the same as or different from the foregoing first adjustment threshold, and the second loss threshold may be the same as or different from the foregoing first loss threshold.

In one case, when the first output layer is the first classification layer, the preset loss function may be a cross-entropy loss function. In another case, when the first output layer is the first regression layer, the preset loss function may be an MSE (mean-square error) loss function.

Looking back at the execution processes of the foregoing steps S110-S170, the above embodiment is described by taking an example that a sample audio feature sequence corresponding to one sample audio is one sample. In another embodiment, the above training process may be performed for a batch of samples, that is, a sample audio feature sequence corresponding to a plurality of sample audios, to separately obtain a mouth shape driving prediction parameter sequence corresponding to a sample audio feature sequence corresponding to each sample audio, and then, on the basis of the mouth shape driving prediction parameter sequence corresponding to the sample audio feature sequence corresponding to each sample audio and a mouth shape driving label parameter sequence corresponding to the sample audio feature sequence, a current prediction loss is determined, and the second extraction layer and the first output layer are trained with a goal of minimizing the current prediction loss. In this embodiment, the current prediction loss is determined for a batch of samples, and then the parameters of the second extraction layer and first output layer are adjusted, so that the number of the adjustments of the parameters of the second extraction layer and first output layer can be reduced, making it easier to implement the training process.

In this embodiment, there is provided a new structure of a mouth shape driving model, where by its second extraction layer, feature extraction and fusion are performed again on a second feature sub-sequence corresponding to sample intermediate features output by a first extraction layer, to extract a sample smoothing feature fused with information of more sample audio features without increasing a sliding window, and a mouth shape driving parameter is generated by using such features, to make a mouth shape animation corresponding to the mouth shape driving parameter smoother, providing foundation for reducing mouth shape jitters in the mouth shape animation.

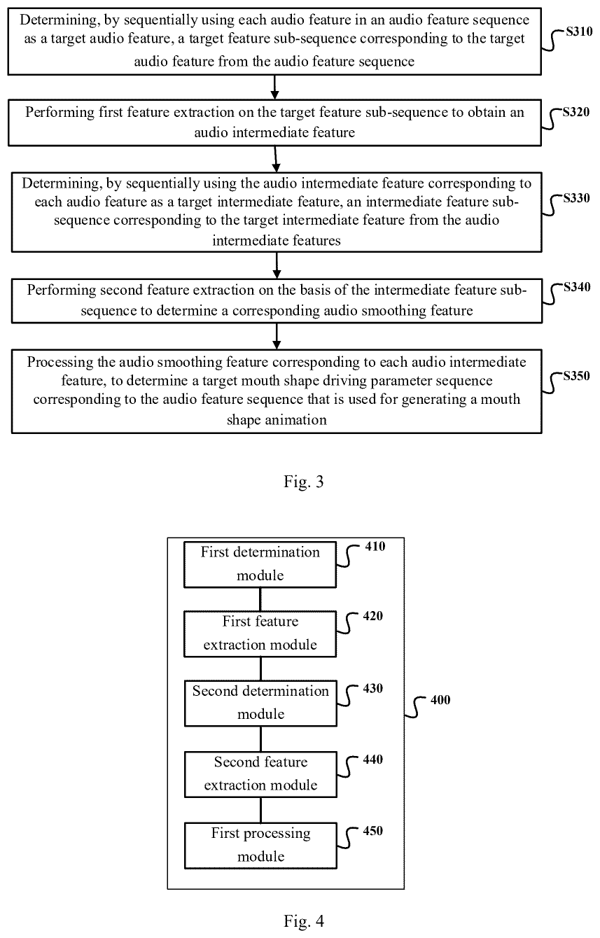

After the mouth shape driving model is trained, it is possible to perform mouth shape driving (i.e. generate a mouth shape animation) by using the mouth shape driving model. FIG. 3 illustrates a schematic flow diagram of a mouth shape driving method in some embodiments of the present disclosure. The method may be implemented by a target program. The target program may be installed in an electronic device, which may be implemented by any apparatus, device, platform, device cluster, etc. having computing and processing capabilities. As shown in FIG. 3, the method includes the following steps:

Step S310, by sequentially using each audio feature in an audio feature sequence as a target audio feature, determining a target feature sub-sequence corresponding to the target audio feature from the audio feature sequence, where the audio feature sequence is a feature sequence obtained by filtering an audio to be processed. The audio to be processed may be any audio data as an input to mouth shape driving (i.e. for generating a mouth shape animation).

For the process of determining the target feature sub-sequence corresponding to the target audio feature from the audio feature sequence, reference may be made to the foregoing process of determining the third feature sub-sequence corresponding to the third feature from the training audio feature sequence, or the foregoing process of determining the first feature sub-sequence corresponding to the first feature from the sample audio feature sequence, which is not repeated here.

Next, step S320, first performing feature extraction on the target feature sub-sequence to obtain an audio intermediate feature. Specifically, first feature extraction may be performed on the target feature sub-sequence by using the foregoing first extraction layer trained, to obtain the audio intermediate feature. For the process of obtaining the audio intermediate feature, reference may be made to the foregoing process of obtaining the sample intermediate feature (or obtaining the training intermediate feature), which is not repeated here.

Then, step S330, by sequentially using the audio intermediate feature corresponding to each audio feature as a target intermediate feature, determining an intermediate feature sub-sequence corresponding to the target intermediate feature from each audio intermediate feature.

In one implementation, the target program may, by sequentially using the audio intermediate feature corresponding to each audio feature as a target intermediate feature, determine an intermediate feature sub-sequence corresponding to the target intermediate feature from each audio intermediate feature by means of a sliding window, where the intermediate feature sub-sequence includes the target intermediate feature, a first number of audio intermediate features before the target intermediate feature and a second number of audio intermediate features after the target intermediate feature. For the process of determining the intermediate feature sub-sequence corresponding to the target intermediate feature, reference may be made to the foregoing process of determining the second feature sub-sequence corresponding to the second feature, which is not repeated here.

Next, step S340, performing second feature extraction on the basis of the intermediate feature sub-sequence to determine a corresponding audio smoothing feature. Specifically, second feature extraction may be performed on the basis of the intermediate feature sub-sequence by using the foregoing second extraction layer trained, to determine the corresponding audio smoothing feature.

In some embodiments, in order to ensure that the audio smoothing feature includes more comprehensive and abundant information, in the step S340, the target program may perform a dimension adjustment operation on each audio intermediate feature in the intermediate feature sub-sequence, to obtain a dimension-adjusted feature sub-sequence including each audio intermediate feature after the dimension adjustment, where the dimension adjustment operation is used for setting dimension sub-features included in each audio intermediate feature as inputs to different channels; and then, perform the second feature extraction on the dimension-adjusted feature sub-sequence to obtain the audio smoothing feature corresponding to the target intermediate feature, to set the dimension sub-features included in each audio intermediate feature as inputs to different channels of a first convolutional layer of the second extraction layer, facilitating fusion of all dimension sub-features of different audio intermediate features, so that the problem of mouth shape jitters in the subsequent mouth shape driving process is better alleviated.

For the above process of performing dimension adjustment operation on each audio intermediate feature in the intermediate feature sub-sequence, reference may be made to the foregoing process of performing dimension adjustment operation on each sample intermediate feature in the second feature sub-sequence, which is not repeated here.

Then, step S350, processing the audio smoothing feature corresponding to each audio intermediate feature to determine a target mouth shape driving parameter sequence corresponding to the audio feature sequence that is used for generating a mouth shape animation. Specifically, the audio smoothing feature corresponding to each audio intermediate feature is processed by using the foregoing first output layer, to determine the target mouth shape driving parameter sequence corresponding to the audio feature sequence that is used for generating the mouth shape animation. When the first output layer is a first classification layer, the target mouth shape driving parameter sequence is a predicted phoneme sequence, and when the first output layer is a first regression layer, the target mouth shape driving parameter sequence is a predicted weight set sequence or a predicted mouth shape key point position set sequence.

For the process of determining the target mouth shape driving parameter sequence corresponding to the audio feature sequence that is used for generating the mouth shape animation, reference may be made to the foregoing process of determining the mouth shape driving prediction parameter sequence corresponding to the sample audio feature sequence, which is not repeated here.

After the target mouth shape driving parameter sequence is obtained, it is possible to generate the corresponding mouth shape animation on the basis of the target mouth shape driving parameter sequence, and then play the mouth shape animation. Specifically, the target program may, when obtaining one target mouth shape driving parameter in the target mouth shape driving parameter sequence, generate a corresponding mouth shape animation frame on the basis of the target mouth shape driving parameter, and then play the mouth shape animation frame, to play the mouth shape animation in real time according to the audio feature sequence.

In this embodiment, the window is slid for the audio intermediate feature corresponding to each audio feature obtained after the first feature extraction, to obtain the corresponding intermediate feature sub-sequence, and then second feature extraction is performed on the intermediate feature sub-sequence, implementing the effect of performing secondary feature extraction on the features obtained after the feature extraction, the audio smoothing feature containing information of more audio features is obtained, the audio smoothing feature containing information of more adjacent audio features can also be obtained without increasing the sliding window, and the generation of the mouth shape driving parameters by using such features can make the mouth shape animation corresponding to the mouth shape driving parameters smoother, reducing mouth shape jitters in the mouth shape animation.

Moreover, a dimension adjustment operation is performed on each audio intermediate feature in the intermediate feature sub-sequence, to set the dimension sub-features included in each audio intermediate feature as the inputs to the different channels of the first convolutional layer of the second extraction layer, which facilitates fusion of all dimension sub-features of different audio intermediate features, and can better alleviate the problem of mouth shape jitters in the subsequent mouth shape driving process.

Specific embodiments of the present disclosure have been described in the foregoing, and other embodiments are within the scope of the appended claims. In some cases, the actions or steps recited in the claims can be performed in a different order than in the embodiments and desired results can still be achieved. In addition, the processes depicted in the accompanying drawings do not necessarily have to be in the specific order shown, or in a continuous order, to achieve desired results. In some embodiments, multitasking and parallel processing may also be possible or may be advantageous.

Corresponding to the above method embodiments, the embodiments of the present disclosure provide a mouth shape driving apparatus 400, a schematic block diagram of which is shown in FIG. 4, including:

a first determination module 410 configured to determine, by sequentially using each audio feature in an audio feature sequence as a target audio feature, a target feature sub-sequence corresponding to the target audio feature from the audio feature sequence, where the audio feature sequence is a feature sequence obtained by filtering an audio to be processed;

a first feature extraction module 420 configured to perform first feature extraction on the target feature sub-sequence to obtain an audio intermediate feature;

a second determination module 430 configured to determine, by sequentially using the audio intermediate feature corresponding to each audio feature as a target intermediate feature, an intermediate feature sub-sequence corresponding to the target intermediate feature from each audio intermediate feature;

a second feature extraction module 440 configured to perform second feature extraction on the basis of the intermediate feature sub-sequence to determine a corresponding audio smoothing feature; and a first processing module 450 configured to process the audio smoothing feature corresponding to each audio intermediate feature, to determine a target mouth shape driving parameter sequence corresponding to the audio feature sequence that is used for generating a mouth shape animation.

In an optional implementation, the second feature extraction module 440 includes:

an adjustment unit (not shown in the figure) configured to perform a dimension adjustment operation on each audio intermediate feature in the intermediate feature sub-sequence, to obtain a dimension-adjusted feature sub-sequence including each audio intermediate feature after dimension adjustment, where the dimension adjustment operation is used for setting dimension sub-features included in each audio intermediate feature as inputs to different channels; and a feature extraction unit (not shown in the figure) configured to perform the second feature extraction on the dimension-adjusted feature sub-sequence to obtain an audio smoothing feature corresponding to the target intermediate feature.

In an optional implementation, the feature extraction unit is specifically configured to perform the second feature extraction on the dimension-adjusted feature sub-sequence by using a fully convolutional network.

In an optional implementation, the second determination module 430 is specifically configured to determine the intermediate feature sub-sequence corresponding to the target intermediate feature from each audio intermediate feature by means of a sliding window, where the intermediate feature sub-sequence includes the target intermediate feature, a first number of audio intermediate features before the target intermediate feature, and a second number of audio intermediate features after the target intermediate feature.

In an optional implementation, the apparatus further includes:

a first acquisition module (not shown in the figure) configured to acquire the audio to be processed; and a filtering module (not shown in the figure) configured to filter the audio to be processed by using a preset Mel frequency cepstrum coefficient (MFCC) filtering algorithm, to obtain the audio feature sequence.

In an optional implementation, the target mouth shape driving parameter sequence is a predicted phoneme sequence, or a predicted weight set sequence, or a predicted mouth shape key point position set sequence.

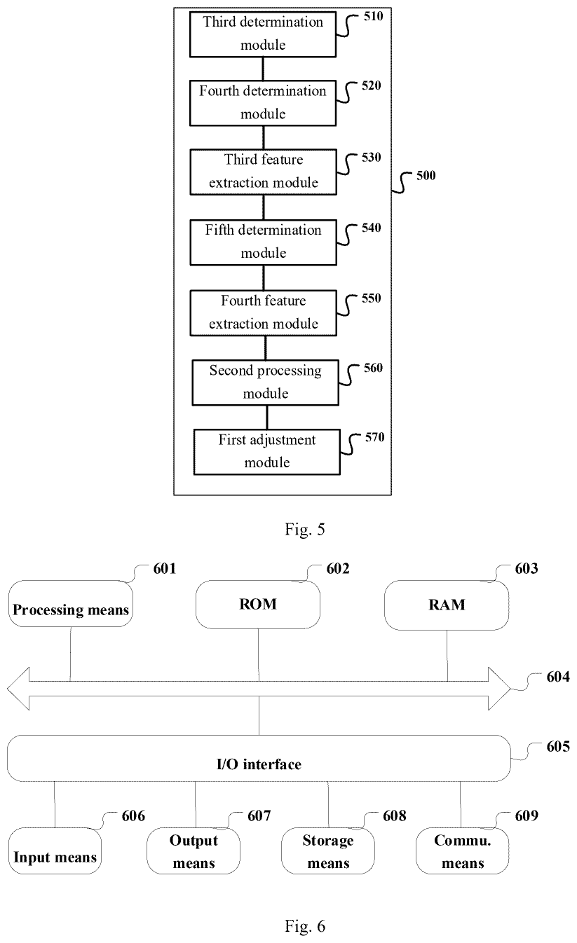

Corresponding to the above method embodiments, the embodiments of the present disclosure provide a training apparatus 500 for a mouth shape driving model, where the mouth shape driving model includes a first extraction layer, a second extraction layer, and a first output layer; and a schematic block diagram of which is shown in FIG. 5, including:

a third determination module 510 configured to determine a current parameter of the first extraction layer; a fourth determination module 520 configured to determine, by sequentially using each sample audio feature in a sample audio feature sequence as a first feature, a first feature sub-sequence corresponding to the first feature from the sample audio feature sequence, where the sample audio feature sequence is a feature sequence obtained by filtering a sample audio;

a third feature extraction module 530 configured to perform first feature extraction on the first feature sub-sequence by using the current parameter of the first extraction layer to obtain a sample intermediate feature;

a fifth determination module 540 configured to determine, by sequentially using the sample intermediate feature corresponding to each sample audio feature as a second feature, a second feature sub-sequence corresponding to the second feature from the sample intermediate features;

a fourth feature extraction module 550 configured to perform second feature extraction on the basis of the second feature sub-sequence by using the second extraction layer to determine a corresponding sample smoothing feature;

a second processing module 560 configured to process the sample smoothing feature corresponding to each sample intermediate feature by using a first classification layer or first regression layer, to determine a mouth shape driving prediction parameter sequence corresponding to the sample audio feature sequence; and a first adjustment module 570 configured to adjust parameters of the second extraction layer and first output layer on the basis of the mouth shape driving prediction parameter sequence and a mouth shape driving label parameter sequence corresponding to the sample audio feature sequence.

In an optional implementation, the first adjustment module 570 is specifically configured to determine a prediction loss on the basis of the mouth shape driving prediction parameter sequence and the mouth shape driving label parameter sequence corresponding to the sample audio feature sequence; and adjust the parameters of the second extraction layer and the first output layer with a goal of minimizing the prediction loss.

In an optional implementation, the third determination module 510 is specifically configured to acquire a training audio feature sequence, where the training audio feature sequence is a feature sequence obtained by filtering a training audio; determine, by sequentially using each training audio feature in the training audio feature sequence as a third feature, a third feature sub-sequence corresponding to the third feature from the training audio feature sequence;

perform first feature extraction on the third feature sub-sequence by using a first extraction layer to obtain a training intermediate feature;

process the training intermediate feature corresponding to each training audio feature by using a second output layer, to determine a current mouth shape driving parameter sequence corresponding to the training audio feature sequence; and adjust the parameters of the first extraction layer and second output layer on the basis of the current mouth shape driving parameter sequence and a first mouth shape driving parameter sequence corresponding to the training audio feature sequence.

The above apparatus embodiments correspond to the method embodiments, and for specific description, reference may be made to the description of the method embodiments, which is not repeated here. The apparatus embodiments are obtained on the basis of the corresponding method embodiments, and have the same technical effects as the corresponding method embodiments, and for specific description, reference may be made to the corresponding method embodiments.

In embodiments of the present disclosure, there is provided an electronic device, including a memory and a processor, where the memory has therein stored executable code which, when executed by the processor, implements the method shown in FIG. 1A or FIG. 3. Referring to FIG. 6 below, a schematic structural diagram of an electronic device suitable for implementing the embodiments of the present disclosure is shown. The electronic device shown in FIG. 6 is only an example, and should not bring any limitation to the functions and the scope of use of the embodiments of the present disclosure.

As shown in FIG. 6, the electronic device may include a processing means (e.g., a central processing unit, a graphics processing unit, etc.) 601 that may perform various appropriate actions and processes according to a program stored in a read-only memory (ROM) 602 or a program loaded from a storage means 608 into a random access memory (RAM) 603. In the RAM 603, various programs and data required for the operation of the electronic device 600 are also stored. The processing means 601, the ROM 602, and the RAM 603 are connected to each other via a bus 604. An input/output (I/O) interface 605 is also connected to the bus 604.

Generally, the following means may be connected to the I/O interface 605: an input means 606 including, for example, a touch screen, touchpad, keyboard, mouse, etc.; an output means 607 including, for example, a liquid crystal display (LCD), speaker, vibrator, etc.; the storage means 608 including, for example, a magnetic tape, hard disk, etc.; and a communication means 609. The communication means 609 may allow the electronic device to communicate with other devices wirelessly or by wire to exchange data. While FIG. 6 illustrates the electronic device having various means, it should be understood that there is no requirement that all the illustrated means are implemented or provided. More or fewer means may be alternatively implemented or provided. Each block shown in FIG. 6 may represent one means or may represent a plurality of means as needed.

In particular, according to embodiments of the present disclosure, the processes described above with reference to the flow diagrams may be implemented as a computer software program. For example, embodiments of the present disclosure include a computer program product, which includes a computer program carried on a computer-readable medium, the computer program including program code for performing the method illustrated by the flow diagrams. In such embodiments, the computer program may be downloaded and installed from a network via the communication means 609, or installed from the storage means 608, or installed from the ROM 602. The computer program, when executed by the processing means 601, performs the above functions defined in the method of the embodiments of the present disclosure.

In embodiments of the present disclosure, there is also provided a computer-readable storage medium having thereon stored a computer program which, when executed in a computer, causes the computer to perform the mouth shape driving method shown in FIG. 3 or the training method for the mouth shape driving model shown in FIG. 1A provided in the present disclosure.

It should be noted that the computer-readable medium according to the embodiments of the present disclosure may be a computer-readable signal medium or a computer-readable storage medium or any combination of the two. The computer-readable storage medium may be, for example, but not limited to, an electronic, magnetic, optical, electromagnetic, infrared, or semiconductor system, apparatus, or device, or any combination of the foregoing. More specific examples of the computer-readable storage medium may include, but are not limited to: an electrical connection having one or more wires, portable computer diskette, hard disk, random access memory (RAM), read-only memory (ROM), erasable programmable read-only memory (EPROM or flash memory), optical fiber, portable compact disc read-only memory (CD-ROM), optical storage device, magnetic storage device, or any suitable combination of the foregoing. In the embodiments of the present disclosure, the computer-readable storage medium may be any tangible medium containing or storing a program which can be used by or in conjunction with an instruction execution system, apparatus, or device. In the embodiments of the present disclosure, however, the computer-readable signal medium may include a data signal propagated in baseband or as part of a carrier wave, in which computer-readable program code is carried. Such a propagated data signal may take any of a variety of forms, including, but not limited to, an electromagnetic, optical signal, or any suitable combination of the forgoing. The computer-readable signal medium may also be any computer-readable medium other than the computer-readable storage medium, where the computer-readable signal medium can send, propagate, or transmit a program for use by or in conjunction with an instruction execution system, apparatus, or device. The program code contained on the computer-readable medium may be transmitted using any appropriate medium, including but not limited to: a wire, optical cable, RF (Radio Frequency), etc., or any suitable combination of the foregoing.

The above computer-readable medium may be contained in the above electronic device; or may exist separately without being assembled into the electronic device. The above computer-readable medium has thereon carried one or more programs which, when executed by the electronic device, cause the electronic device to determine, by sequentially using each audio feature in an audio feature sequence as a target audio feature, a target feature sub-sequence corresponding to the target audio feature from the audio feature sequence, where the audio feature sequence is a feature sequence obtained by filtering an audio to be processed; perform first feature extraction on the target feature sub-sequence to obtain an audio intermediate feature; determine, by sequentially using the audio intermediate feature corresponding to each audio feature as a target intermediate feature, an intermediate feature sub-sequence corresponding to the target intermediate feature from each audio intermediate feature; perform second feature extraction on the basis of the intermediate feature sub-sequence to determine a corresponding audio smoothing feature; and process the audio smoothing feature corresponding to each audio intermediate feature, to determine a target mouth shape driving parameter sequence corresponding to the audio feature sequence that is used for generating a mouth shape animation. Or the one or more programs cause the electronic device to determine a current parameter of the first extraction layer; determine, by sequentially using each sample audio feature in a sample audio feature sequence as a first feature, a first feature sub-sequence corresponding to the first feature from the sample audio feature sequence, where the sample audio feature sequence is a feature sequence obtained by filtering a sample audio; perform first feature extraction on the first feature sub-sequence by using the current parameter of the first extraction layer to obtain a sample intermediate feature; determine, by sequentially using the sample intermediate feature corresponding to each sample audio feature as a second feature, a second feature sub-sequence corresponding to the second feature from the sample intermediate features; perform second feature extraction on the basis of the second feature sub-sequence by using the second extraction layer to determine a corresponding sample smoothing feature; process the sample smoothing feature corresponding to each sample intermediate feature by using the first output layer to determine a mouth shape driving prediction parameter sequence corresponding to the sample audio feature sequence; and adjust parameters of the second extraction layer and first output layer on the basis of the mouth shape driving prediction parameter sequence and a mouth shape driving label parameter sequence corresponding to the sample audio feature sequence.

Computer program code for performing the operations of the embodiments of the present disclosure may be written in one or more programming languages or a combination thereof, where the programming language includes an object-oriented programming language such as Java, Smalltalk, and C++, and also includes a conventional procedural programming language, such as a “C” language or similar programming language. The program code may be executed entirely on a user's computer, partly on a user's computer, as a stand-alone software package, partly on a user's computer and partly on a remote computer, or entirely on a remote computer or server. In a scenario where a remote computer is involved, the remote computer may be connected to a user's computer through any type of network, including a local area network (LAN) or wide area network (WAN), or may be connected to an external computer (for example, through the Internet using an Internet service provider).

The embodiments in the present disclosure are described in a progressive manner, and for same and similar parts between the embodiments, reference can be made to each other, and each embodiment focuses on differences from other embodiments. In particular, for the storage medium and computing device embodiments, since they are substantially similar to the method embodiments, the description is relatively simple, and reference may be made to the description of the method embodiments for related points.

Those skilled in the art should recognize that in one or more of the examples described above, the functions described in the embodiments of the present disclosure may be implemented in hardware, software, firmware, or any combination thereof. When implemented in software, the functions may be stored in a computer-readable medium or transmitted as one or more instructions code on a computer-readable medium.

The further detailed description of the objectives, technical solutions and beneficial effects of the embodiments of the present disclosure has been made in the specific implementations described above. It should be understood that the content described above is only the specific implementation of the embodiments of the present disclosure, and is not intended to limit the scope of protection of the present disclosure, and any modifications, equivalent substitutions, improvements and the like made on the basis of the technical solutions of the present disclosure should be included in the scope of the present disclosure.

1. A mouth shape driving method, comprising:
determining, by sequentially using each audio feature in an audio feature sequence as a target audio feature, a target feature sub-sequence corresponding to the target audio feature from the audio feature sequence, wherein the audio feature sequence is a feature sequence obtained by filtering an audio to be processed;
performing first feature extraction on the target feature sub-sequence to obtain an audio intermediate feature;
determining, by sequentially using the audio intermediate feature corresponding to each audio feature as a target intermediate feature, an intermediate feature sub-sequence corresponding to the target intermediate feature from each audio intermediate feature;
performing second feature extraction on the basis of the intermediate feature sub-sequence to determine a corresponding audio smoothing feature; and
processing the audio smoothing feature corresponding to each audio intermediate feature, to determine a target mouth shape driving parameter sequence corresponding to the audio feature sequence that is configured to generate a mouth shape animation.

2. The method according to claim 1, wherein performing second feature extraction on the basis of the intermediate feature sub-sequence to determine a corresponding audio smoothing feature comprises:
performing a dimension adjustment operation on each audio intermediate feature in the intermediate feature sub-sequence to obtain a dimension-adjusted feature sub-sequence comprising each audio intermediate feature after dimension adjustment, wherein the dimension adjustment operation is configured to set each dimension sub-feature comprised in each audio intermediate feature as input to different channels; and
performing the second feature extraction on the dimension-adjusted feature sub-sequence to obtain the audio smoothing feature corresponding to the target intermediate feature.

3. The method according to claim 1, wherein performing the second feature extraction on the dimension-adjusted feature sub-sequence comprises:
performing the second feature extraction on the dimension-adjusted feature sub-sequence by using a fully convolutional network.

4. The method according to claim 1, wherein determining an intermediate feature sub-sequence corresponding to the target intermediate feature from each audio intermediate feature comprises:
determining the intermediate feature sub-sequence corresponding to the target intermediate feature from each audio intermediate feature by means of a sliding window, wherein the intermediate feature sub-sequence comprises the target intermediate feature, a first number of audio intermediate features before the target intermediate feature, and a second number of audio intermediate features after the target intermediate feature.

5. The method according to claim 1, further comprising:
acquiring the audio to be processed; and
filtering the audio to be processed by using a preset Mel frequency cepstrum coefficient (MFCC) filtering algorithm, to obtain the audio feature sequence.

6. The method according to claim 1, wherein the target mouth shape driving parameter sequence is a predicted phoneme sequence, or a predicted weight set sequence, or a predicted mouth shape key point position set sequence.

7. A training method for a mouth shape driving model, wherein the mouth shape driving model comprises a first extraction layer, a second extraction layer and a first output layer;
the method comprising:
determining a current parameter of the first extraction layer;
determining, by sequentially using each sample audio feature in a sample audio feature sequence as a first feature, a first feature sub-sequence corresponding to the first feature from the sample audio feature sequence, wherein the sample audio feature sequence is a feature sequence obtained by filtering a sample audio;
performing first feature extraction on the first feature sub-sequence by using the current parameter of the first extraction layer to obtain a sample intermediate feature;
determining, by sequentially using the sample intermediate feature corresponding to each sample audio feature as a second feature, a second feature sub-sequence corresponding to the second feature from the sample intermediate features;
performing second feature extraction on the basis of the second feature sub-sequence by using the second extraction layer to determine a corresponding sample smoothing feature;
processing the sample smoothing feature corresponding to each sample intermediate feature by using the first output layer, to determine a mouth shape driving prediction parameter sequence corresponding to the sample audio feature sequence; and
adjusting parameters of the second extraction layer and first output layer on the basis of the mouth shape driving prediction parameter sequence and a mouth shape driving label parameter sequence corresponding to the sample audio feature sequence.

8. The method according to claim 7, wherein adjusting parameters of the second extraction layer and first output layer comprises:
determining a prediction loss on the basis of the mouth shape driving prediction parameter sequence and the mouth shape driving label parameter sequence corresponding to the sample audio feature sequence; and
adjusting the parameters of the second extraction layer and the first output layer with a goal of minimizing the prediction loss.

9. The method according to claim 7, wherein determining a current parameter of the first extraction layer comprises:
acquiring a training audio feature sequence, wherein the training audio feature sequence is a feature sequence obtained by filtering a training audio;
determining, by sequentially using each training audio feature in the training audio feature sequence as a third feature, a third feature sub-sequence corresponding to the third feature from the training audio feature sequence;
performing first feature extraction on the third feature sub-sequence by using the first extraction layer to obtain a training intermediate feature;
processing the training intermediate feature corresponding to each training audio feature by using a second output layer, to determine a current mouth shape driving parameter sequence corresponding to the training audio feature sequence; and
adjusting parameters of the first extraction layer and second output layer on the basis of the current mouth shape driving parameter sequence and a first mouth shape driving parameter sequence corresponding to the training audio feature sequence, until the first extraction layer and the second output layer reach a first convergence condition, to obtain the current parameter of the first extraction layer.

10-11. (canceled)

12. An electronic device, comprising a memory and a processor, wherein the memory has therein stored executable code which, when executed by the processor, implements the method according to claim 1.

13. A non-transitory computer-readable storage medium having thereon stored computer-executable instructions which, when executed by a processor, implement the method according to claim 1.

14. (canceled)

15. An electronic device, comprising a memory and a processor, wherein the memory has therein stored executable code which, when executed by the processor, implements the method according to claim 7.

16. A non-transitory computer-readable storage medium having thereon stored computer-executable instructions which, when executed by a processor, implement the method according to claim 7.

17. The electronic device according to claim 12, wherein performing second feature extraction on the basis of the intermediate feature sub-sequence to determine a corresponding audio smoothing feature comprises:
performing a dimension adjustment operation on each audio intermediate feature in the intermediate feature sub-sequence to obtain a dimension-adjusted feature sub-sequence comprising each audio intermediate feature after dimension adjustment, wherein the dimension adjustment operation is configured to set each dimension sub-feature comprised in each audio intermediate feature as input to different channels; and
performing the second feature extraction on the dimension-adjusted feature sub-sequence to obtain the audio smoothing feature corresponding to the target intermediate feature.

18. The electronic device according to claim 12, wherein performing the second feature extraction on the dimension-adjusted feature sub-sequence comprises:
performing the second feature extraction on the dimension-adjusted feature sub-sequence by using a fully convolutional network.

19. The electronic device according to claim 12, wherein determining an intermediate feature sub-sequence corresponding to the target intermediate feature from each audio intermediate feature comprises:
determining the intermediate feature sub-sequence corresponding to the target intermediate feature from each audio intermediate feature by means of a sliding window, wherein the intermediate feature sub-sequence comprises the target intermediate feature, a first number of audio intermediate features before the target intermediate feature, and a second number of audio intermediate features after the target intermediate feature.

20. The electronic device according to claim 12, wherein the method further comprises:
acquiring the audio to be processed; and
filtering the audio to be processed by using a preset Mel frequency cepstrum coefficient (MFCC) filtering algorithm, to obtain the audio feature sequence.

21. The electronic device according to claim 12, wherein the target mouth shape driving parameter sequence is a predicted phoneme sequence, or a predicted weight set sequence, or a predicted mouth shape key point position set sequence.

22. The electronic device according to claim 15, wherein adjusting parameters of the second extraction layer and first output layer comprises:
determining a prediction loss on the basis of the mouth shape driving prediction parameter sequence and the mouth shape driving label parameter sequence corresponding to the sample audio feature sequence; and
adjusting the parameters of the second extraction layer and the first output layer with a goal of minimizing the prediction loss.

23. The electronic device according to claim 15, wherein determining a current parameter of the first extraction layer comprises:
acquiring a training audio feature sequence, wherein the training audio feature sequence is a feature sequence obtained by filtering a training audio;
determining, by sequentially using each training audio feature in the training audio feature sequence as a third feature, a third feature sub-sequence corresponding to the third feature from the training audio feature sequence;
performing first feature extraction on the third feature sub-sequence by using the first extraction layer to obtain a training intermediate feature;
processing the training intermediate feature corresponding to each training audio feature by using a second output layer, to determine a current mouth shape driving parameter sequence corresponding to the training audio feature sequence; and
adjusting parameters of the first extraction layer and second output layer on the basis of the current mouth shape driving parameter sequence and a first mouth shape driving parameter sequence corresponding to the training audio feature sequence, until the first extraction layer and the second output layer reach a first convergence condition, to obtain the current parameter of the first extraction layer.
